(19) United States
(12) Patent Application Publication
(10) Pub. No.: US 2006/0257815 A1
(43) Pub. Date: Nov. 16, 2006

(54) Device for simulating the effects of an orthodontic appliance

(76) Inventor: Vincenzo De Dominicis, Napoli (IT)

Correspondence Address: YOUNG & THOMPSON, 745 SOUTH 23RD STREET, 2ND FLOOR, ARLINGTON, VA, 22202, US

(21) Appl. No.: 11/397,634

(22) Filed: Apr. 5, 2006

Related U.S. Application Data
(60) Provisional application No. 60/668,171, filed on Apr. 5, 2005.

(51) Int. Cl. A61C 3/00

(52) U.S. Cl. 433/24

(57) ABSTRACT

A device for simulating the effects of a conventional orthodontic appliance on a virtual model of a patient's dental arches, includes:

a processor (1) presenting a processing unit, interface elements having at least one display unit; and at least one memory for storing: at least one virtual model of the arches, and for at least one conventional orthodontic technique, characteristics identifying at least one orthodontic appliance for implementing the technique, standard parameters of the positioning of the orthodontic appliance, and at least one standard activation thereof, a program executable by the processor allowing said virtual model to be accessed and displayed on the display unit, the program including navigation instruments for selecting the standard orthodontic technique, the relative standard appliance and the standard activation, the memory including one parameter describing characteristics of resistance to movement of teeth subjected to action of a conventional orthodontic appliance.

The present invention relates to a device for simulating the effects of an orthodontic appliance, in accordance with the pre-characterising part of the main claim.

Devices have long been known for supporting and facilitating the planning of an orthodontic treatment and for constructing the planned orthodontic appliances, see for example patent application US2004/0073417, and patents U.S. Pat. No. 5,518,397, U.S. Pat. No. 5,395,238, U.S. Pat. No. 6,632,089.

Although the documents of the known art describe devices for three-dimensionally displaying a patient's teeth and the relative malocclusions and offer the possibility of selecting different orthodontic techniques, the relative appliances for implementing a selected technique and particular activations of said appliances, the problem always arises of facilitating the choice and the design of the most suitable orthodontic appliance for solving a particular malocclusion problem of a patient.

The documents of the known art always propose arbitrary simulation of the movements induced in the teeth by the appliance and by the relative activation chosen.

This simulation substantially imitates the normal practice of an orthodontist who, for a determined malocclusion of a patient, selects a technique, a relative orthodontic appliance and a relative activation on the basis of his experience, which enables him to empirically predict what the movement of a tooth will be to which a given appliance with a determined activation is applied.

An object of the present invention is to provide a device able to offer an orthodontist or an orthodontics student an instrument able to help in choosing the most effective technique and the relative appliance and activation for treating a particular malocclusion and which in particular is able to provide information relative to the biomechanics generated on the dental arches in relation to a selected orthodontic technique, appliance and activation applied to the arches.

A further object is to provide an instrument which displays the tooth movement generated by the application of a particular selected technique, appliance and activation which takes account of the forces acting on the teeth.

A further object is to provide a device which is highly interactive and enables the orthodontist to easily and rapidly observe and analyze the effects of a particular technique, appliance and activation on the teeth.

These and other objects which will be apparent to an expert of the art are attained by a device in accordance with the characterising part of the following claims.

The present invention will be more apparent from the accompanying drawings, which are provided by way of non-limiting example and in which:

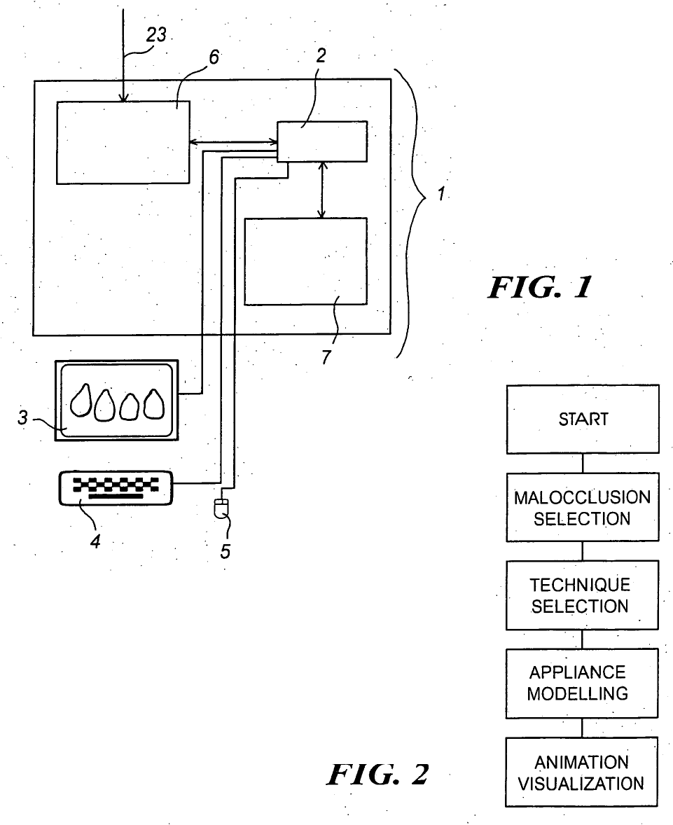

FIG. 1 is a block diagram of the device of the invention,

FIG. 2 is a block diagram of the principal operations implemented by the device,

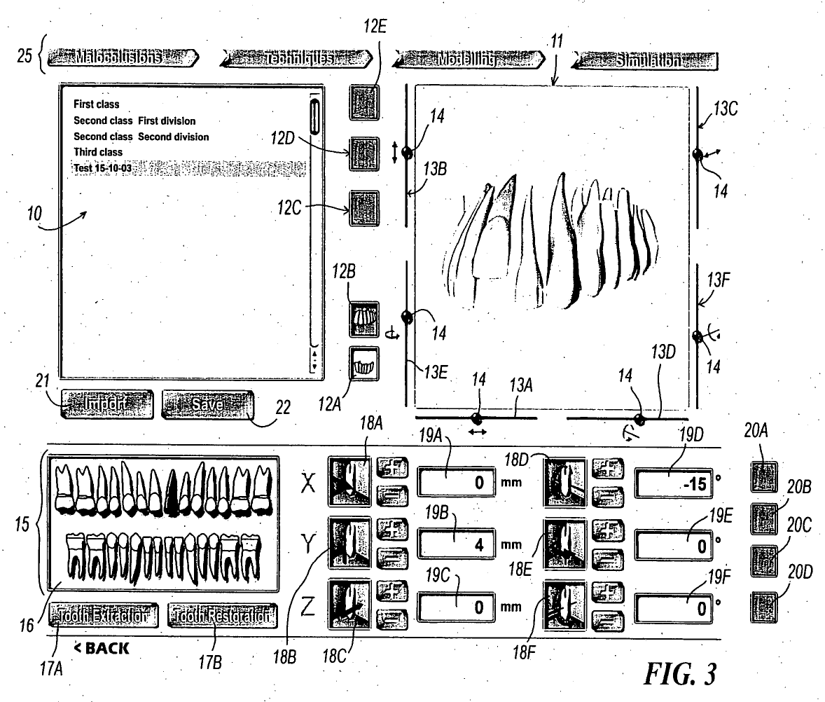

FIGS. 3-6 show four screen representations of a processor programme for implementing the invention,

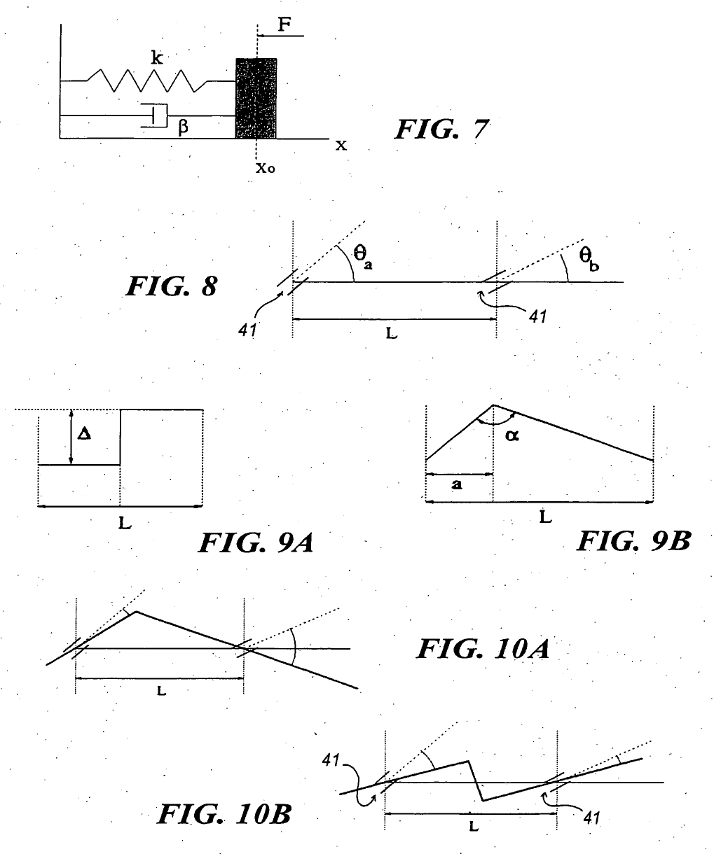

FIGS. 7-10 are schematic views of models of the forces applied to a tooth to which an orthodontic appliance is applied (FIG. 7), and of different orthodontic appliances applied to two adjacent teeth respectively (FIGS. 8-10).

With reference to FIG. 1, a device of the invention comprises a processor indicated overall by 1 presenting at least one processing unit or CPU 2, interface means comprising a display unit 3, a keyboard 4 and a mouse 5, a main memory 6, for example of RAM type, and a hard disc 7. Processors of this type are totally conventional and will not be further described in detail. The processor has an installed programme enabling it to perform a series of operations described in detail hereinafter and shown schematically in FIG. 2. Once the programme has started, these operations make it possible to select a particular type of malocclusion, to select an orthodontic technique to resolve the selected malocclusion, to virtually model an orthodontic appliance and to display the effect of said appliance on the dental arches.

For reasons of simplicity and descriptive clarity the invention is illustrated hereinafter mainly on the basis of the screen representations displayed on the screen 3 and the essential functional characteristics comprised in said screen representations. An expert of the art is able to programme a processor to perform these functions in the light of the following information and of the description of the screen representations and their function.

With reference to FIG. 3, this shows a representation of the window which opens on selecting “malocclusions” from the menu 25 at the top of the screen on opening the programme (not shown but of conventional type). This step allows selection of the particular malocclusion to be studied, i.e. that malocclusion for which the most effective orthodontic technique and the relative appliance and activation are to be investigated. The malocclusion representation of FIG. 3 presents a first window 10 containing a plurality of standard malocclusions of the type known in the literature, selectable by the device user: for example malocclusions of first, second (first and second division), third class.

The operation of selecting an item in a window by the mouse 5 or keyboard 4 is conventional.

By selecting one of the malocclusions of the window 10 and the virtual command “load” 21 the selected malocclusion is automatically displayed in the adjacent window 11. By selecting one of the virtual commands 12 A-D, the following can be respectively displayed: only the lower arch, only the upper arch, both the arches, only the left half arches, only the right half arches. Using the commands 13 A-F, of virtual slider type 14, the user can also modify the display viewpoint of the arch in the window 11.

More particularly, by moving the virtual slider 14 of the commands 13 A,B,C respectively, the displayed image can be shifted relative to the x, y and z axes, whereas by using the commands 13 D,E,F they can be rotated relative to said axes. In this manner the user can optimally display all selected types of malocclusions. In. FIG. 3 only the upper arch is displayed, the relative command 12B having been selected.

To implement said operations, the position and orientation of each tooth with respect to a fixed Cartesian reference system is identified, in a manner conventional for the expert of the art, by means of a transformation matrix for each tooth. Usual three-dimensional display programmes, for example of CAD type, are used to control the aforedescribed operations of completely or partially displaying the dental arches and moving the observation point. To enable one of the standard malocclusions of the window 10 to be selected, the device memory 6 comprises tooth by tooth the data relative to the position and rotation of each tooth for each of said standard malocclusions relative to a fixed Cartesian reference axis.

By means of the windows and the commands indicated overall by 15 on the lower part of the screen 11, the selected standard malocclusion can be personalized via the window 10. More particularly, the window 16 presents a two-dimensional representation of the teeth of the upper and lower arches; by clicking onto one of the teeth it can be selected and the following operations be implemented: elimination of the tooth (to simulate a completed extraction of the selected tooth) (command 17 A), restoration of the tooth (command 17 B), movement or rotation of the selected tooth with respect to the x y z directions (command 18 A-F), inserting in millimetres or degrees the desired positive or negative movement or rotation for the selected tooth (command 1,9 A-F).

Similar movement operations relative to the x-y-z axes can also be implemented for the entire upper or lower arch by operating the commands 20 A, arch selection, and 20 B-D, selection of the extent of movement relative to the three axes.

Each of the selected personalizations is immediately displayed in the window 11. Again in this case the implementation of said operations is conventional for the expert of the art using known three-dimensional programmes.

It should be noted that by virtue of the window icons and the commands 16-19, graphically carrying the relative function, personalization of the selected standard malocclusion is particularly simple and intuitive.

By means of the virtual command 12, indicated by “save” in FIG. 3, a personalized malocclusion can be saved in the device memory 6; the identifying code (in the example “test 15-10-03”) for the saved personalized malocclusion appears in the standard malocclusion window 10 and can be again displayed. These operations, of conventional type for the expert of the art, will not be described in detail.

By means of the malocclusions window the device user can therefore select a standard malocclusion to be studied, or can create a malocclusion which reproduces in detail the actual malocclusion of a particular patient.

According to a variant not shown in detail, the invention can also receive, memorize and display malocclusions of actual patients obtained using acquisition instruments of known type, for example by scanner, radiological equipment, ultrasound equipment, with determinations which can be made both on the actual teeth of the patient or on models thereof, as described for example in US 2004/0073417, the contents of which together with the patents and patent applications cited in it are to be considered included in the present text.

The device of the invention therefore comprises an acquisition line 23 (FIG. 1) for data originating from a three-dimensional measuring apparatus for a patient's teeth, these data being stored in the hard disk 7 of the device and processed by the CPU 2 in matrix form, then stored in the memory 6, to be used in a manner similar to that previously described.

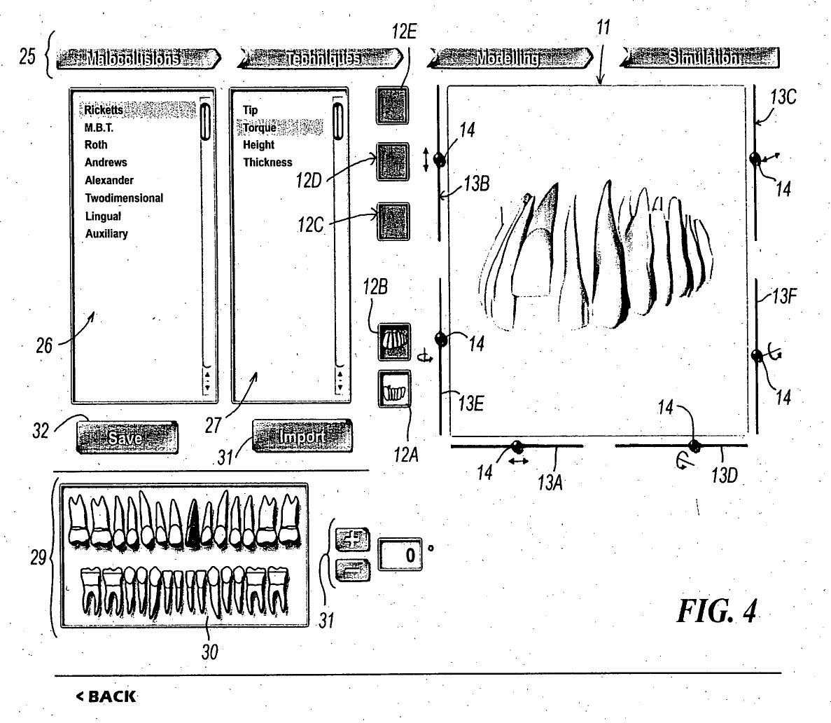

FIG. 4 shows the screen representation which opens on selecting the operation “techniques” from the menu 25; this screen comprises a window 26 comprising a plurality of standard orthodontic techniques, a window 27 comprising the four standard parameters characteristic of the positioning of the brackets of the orthodontic appliance for the selected technique, a window displaying the dental arches identical to the window 11 previously described, and a section 29 enabling said standard parameters to be modified. As is known to the expert of the art each orthodontic technique provides, for each tooth, devices to be applied to the teeth, hereinafter known as brackets, of standard type and shape and comprising, for each tooth, standard application points and positions, known in the literature. These application points and positions for the brackets are conventionally identified by four significant parameters usual for the expert of the art: tip, torque, height and thickness. According to the invention, for each known orthodontic technique and for each tooth the device comprises in its memory the relative standard tip, torque, height and thickness values. For example the known tip, torque, thickness and height values are memorized for the following techniques: Ricketts, M. B. T., Roth, Andrews, Alexander, Two-dimensional, Lingual.

Having selected the desired technique via the window 26 the relative values are loaded and made available to the processing programme by operating the virtual screen command 31.

The standard tip, torque height and thickness values can be modified tooth by tooth via the section 29. To achieve this the technique to be simulated is selected from the window 26, then the parameter to be modified is selected from the window 27, for example the torque, then a tooth for which the standard torque value is to be varied is selected from the window 30, the virtual commands of the window 31 are used to increase or decrease this standard value.

The modification is then saved in the memory 6 by operating the relative virtual command 32, in a manner conventional to the expert of the art and made available in the techniques list of window 26.

It should be noted that as shown in FIG. 4 the window 28 does not display the brackets relative to the particular technique selected nor their positioning, but only the malocclusion selected in the preceding operation relative to the “malocclusion” step. However in a variant, not shown, the brackets or at least a simplified graphic representation (for example three- or two-dimensional) can be automatically displayed in addition to their positioning on the teeth of the previously selected particular malocclusion. Displays of this type are described for example in the already cited patent application US2004/0073417 and in the relative patents and applications cited therein.

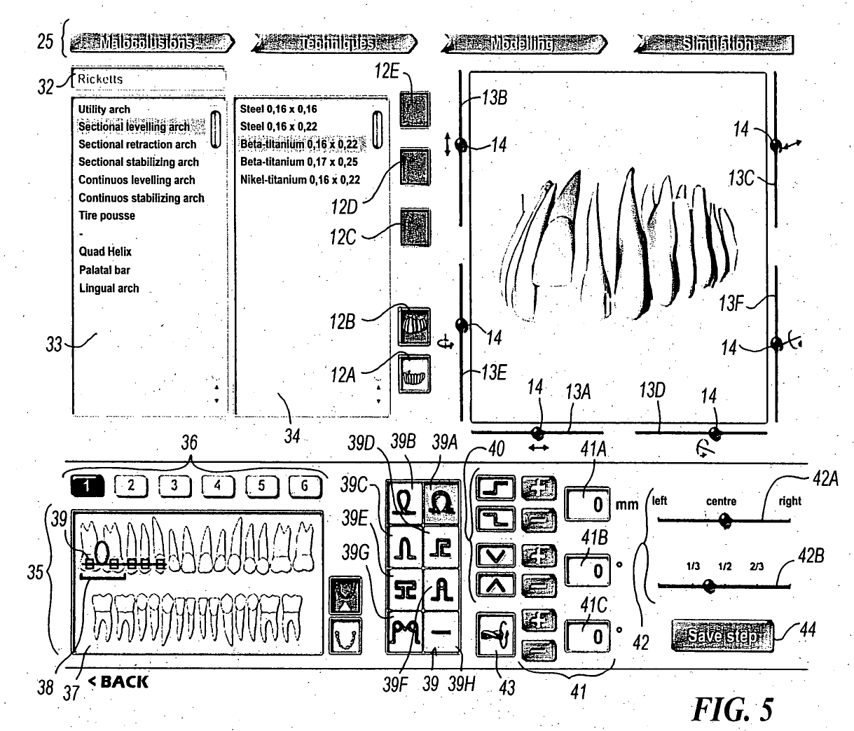

FIG. 5 shows the screen representation which opens on selecting “modelling” from the menu 25; this screen representation comprises a window 32 in which the name of the technique selected in the previously described operating step, a window 33 for the selected technique lists all the different conventional types of arch usable, a window 34 which for each type of arch lists all the different conventional wires usable, and a section 35 for selecting the type of activation desired for the particular arch and wire selected.

For each orthodontic technique it is known to the expert of the art to use a plurality of known conventional types of arch, for example for the Ricketts technique it is known to use a utility arch, a sectional levelling, or retraction, or stabilizing arch, or a continuous levelling or stabilizing arch, or a “tire pousse” or a quad helix or a palatal bar or a lingual arch. For each technique and relative arch it is also conventional for the expert of the art to use a plurality of wires having different technical characteristics; for example for the Ricketts technique and a sectional levelling arch it is known to use a steel wire of dimensions 0.16×0.16 mm, or 0.16×0.22 mm, or in beta titanium with dimensions 0.16 mm×0.22 mm or 0.17 mm×0.25 mm, or in nickel titanium with dimensions 0.16 mm×0.22 mm.

According to the invention, the possible types of arch usable and for each arch the dimensional characteristics of the possible usable wires are stored in the memory 6 of the device for each of the known orthodontic techniques.

Using the section 35, the user is able to set a preferred activation of the selected appliance, the appliance in the present context meaning the combination of a particular type of arch bracket, dependent on the particular technique selected, and the relative wire. The user firstly selects via one of the virtual pushbuttons 36 that therapy step to which the activation to be selected refers. In this respect it is known that to resolve a malocclusion problem appliances of different type, for example arches of different shape and/or different activations, must be periodically applied to the teeth. Each appliance and the relative activation is arranged to achieve a particular movement of the teeth, which when attained the appliance is no longer effective and must be replaced.

Using the virtual pushbuttons 36 the user is therefore able to select and memorize to which therapy step the current selection refers.

Using the window 37 the user then selects the teeth through which the arch has to pass; in this step all the teeth can be selected or only some as in the example shown in the figure relative to a sectional arch involving only five teeth. This selection is made by clicking onto the teeth to be involved by the arch, a two-dimensional graphic symbol 39 identifying a bracket appearing on the selected teeth. Using a slider 38 a pair of teeth are selected onto which to apply a particular activation of the relative arch. At this point, the virtual pushbuttons 39 are used to select the shape of any loop to give to the arch in the interdental space of the pair of teeth selected. The pushbuttons 39 comprise all the main known loops for an arch, i.e.: an omega loop 39A, a droplet loop 39B, a vertical loop 39C, an L-loop 39D, a T-loop 39E, a looped vertical loop 39F, a double looped vertical loop 39G, no loop 39H. As shown in FIG. 5 the programme automatically displays in the window 37 the type of loop chosen for the particular pair of teeth selected. The virtual pushbuttons 40 are then used to select any bend to be given to the arch within the interdental space selected by the slider 38; the pushbuttons 40 comprise all the known bends, for example stepped 40A-B or V 40C-D or wire twist 43. Having selected a type of bend, its values can be modified via the windows 41 (for stepped bends the window 41A displays the extent of activation in mm; for the V bends the window 41 B displays the extent of activation in degrees and for the wire twist the window 41 C displays the extent of activation in degrees). Any eccentricity of the stepped bend can be set by the slider 42A, and any eccentricity of the V bend by the slider 42B. Having made all the arch, wire and activation choices for a determined step, these are saved in the device memory 6 by the relative “save” command 44.

Finally, the screen representation of FIG. 5 comprises a window for displaying the selected malocclusion identical to the previously described window 11.

It should be noted that according to a variant of the aforedescribed invention, the activation step for the orthodontic appliance could be assisted by the display window 11, either as an alternative to or in combination with the two-dimensional dental arch window 37. In this case the procedure would be as in the previously described case, however the selected brackets, arch and activations would be also displayed three-dimensionally on the three-dimensional graphic representation of the malocclusion which appears in FIG. 11.

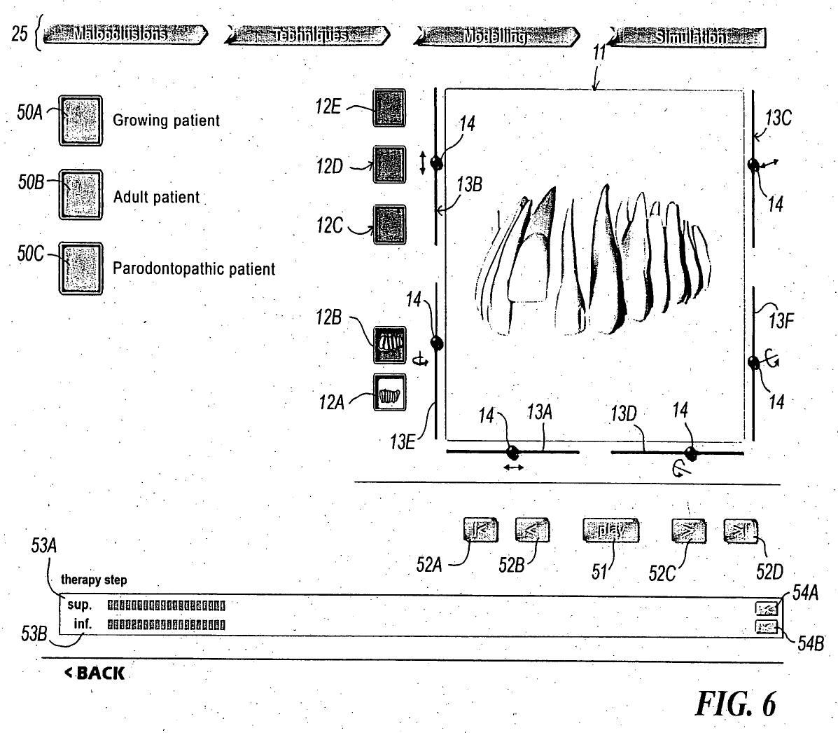

FIG. 6 shows the screen representation which opens on selecting “simulation” from the menu 25.

To activate the animation, the user must firstly select the type of patient to receive the selected appliance, for which purpose a plurality of pushbuttons 50A-C are provided, each relative to a particular type of patient, i.e. growing patient, adult patient, parodontopathic patient. According to the invention the device memory 6 contains stored therein for each type of patient a bone tissue model or a plurality of parameters able to characterise the resistance to movement of the teeth of the various types of patient.

Specifically, for each of the three aforesaid types of patient and for each tooth the following data are stored relative to:

elastic constant k1, i.e. a value indicative of the return force acting on the tooth opposing that exerted by the orthodontic appliance and related to the fact that each tooth if subjected to a force tending to displace it has a natural tendency to return to its initial position.

damping factor b, i.e. a value indicative of the friction force acting on the tooth opposing that exerted by the orthodontic appliance,

minimum movement activation threshold, i.e. a value relative to the initial detachment friction, related to the fact that a minimum determined force has to be applied to succeed in displacing each tooth,

interdental elastic bond, i.e. a value which takes account of the existence of the transectal oxytalanic fibres of the parodontal ligament between one tooth and the next,

jaw muscular force i.e. a value which takes account of the pressure acting on the teeth with the mouth closed (for these values reference is made to the Ricketts classification on facial typology: meso, brachy and dolicho),

mass of each tooth

The data relative to the bone tissue model of the three patient types are chosen from the following value range:

elastic constant: 50/100 g

damping factor: 100/200 g/(mm/week)

minimum activation threshold: 20/50 g

interdental elastic bond: 10/20 g

jaw muscular force: 30-50 g

mass of each tooth: 20-30 g

According to the invention, for each tooth the positions of the relative centres of resistance are also stored in the memory 6. As known to the expert of the art, the centre of resistance of a tooth is the point through which any force, or the resultant of a force, must pass to obtain a bodily movement of the tooth. The data relative to the centres of resistance of the various teeth are known in the literature, see for example the article of Burnstone “Location of centers of resistance of anterior teeth during retraction” published in the May 1987 issue of the magazine American Journal of Orthodontics and Dentofacial Orthopedics; article by Burnstone “Holographic determination of centers of rotation produced by orthodontic forces” published in the April 1980 issue of the magazine American Journal of Orhodontics and Dentofacial Orthopedics.

For each type of technique, for each type of arch, for each type of wire, for each type of activation and for each type of standard malocclusion, data relative to the value and/or direction and sense of the forces and moment induced on the tooth by each of said orthodontic appliances are also stored in the device memory 6. These values can be memorized if the programme enables the user to select a limited number of malocclusions and relative techniques and orthodontic appliances. In these cases the data relative to the value and/or direction and sense of the forces and moment induced on the tooth by each of said orthodontic appliances can be easily obtained by experimental tests and measurements.

If however the device allows all the aforedescribed selections to be made, the device programme calculates each time the force exerted by the particular selected appliance on the teeth of the particular selected malocclusion to which the appliance is applied. Numerous articles confront the subject of calculating the forces induced on the teeth by orthodontic appliances, see for example the articles: “Effects of varying root lengths and alveolar bone heights” AJO-DO July 1991 (66-71) Tanne et al., “Force system developed by V bends in elastic wire” AJO-DO October 1989 (295-301) Ronay et al., “Moment to force ratios and centre of rotation” AJO-Do 1988 (426-431) Tanne et al., “Creative wire bending” AJO-DO January 1988 (59-67) Burnstone et al., “Three dimensional finite element stress analysis” AJO-DO December 1987 (499-505) Tanne et al., “Mechanism of tooth movement” AJO-DO April 1984 (294-307) Smith et al., “The segmented arch approach to space closure” AJO-DO November 1982 (361-378) Burnstone, “Variable modulus orthodontics” AJO-DO July 1981 (1-16) Burnstone, “Force system from an ideal arch” Burnstone et al. AMJ ORTHOD 1974; 65:270-89; Vanderby et al. “Experimentally determined force systems from vertically activated orthodontic loops” Angle Orthod 1977, 47:272-9, Koenig et al. “Force systems from orthodontic appliances: an analytical and experimental comparison” J Biomec Eng, 1980; 102.294-300; Burnstone et al. “Maximum forces and deflections from orthodontic appliances” AM J Orthod 1983 84: 95-103.

The programme comprises a step of quantitatively calculating the force generated by the orthodontic appliance which does not take account of the position of the tooth and of the appliance brackets and a quantitative calculation step which takes account of said positions identifies the orientation of said force and relative movement. For both these calculation steps each appliance is considered to be a wire divided into a plurality of segmented arches, consequently the force system generated by the arch of an appliance is studied considering the wire portion present between two consecutive teeth or connections.

With regard to the quantitative step the programme calculates the load/movement ratio applied by the appliance and the relative movement, using Hook's law for the calculation according to which this ratio is equal to an elastic constant characteristic of the wire used multiplied by the wire cross-section to wire length ratio.

Each time the user chooses an arch from the available menu and establishes on which teeth it has to pass, the calculation unit applies Hooke's law to that determined wire, then knowing its length, its cross-section and its modulus of elasticity, it obtains the relative load/movement ratio. In this respect, a loop or a bend are seen by the programme as an additional length of wire, of known dimension, which can be added into the interconnection space, then again using Hooke's law the programme calculates any force system generated by the particular activation selected for said loops or bends.

Regarding an evaluation of the applied force, the programme of the invention is based on the aforesaid studies of Burnstone the content of which is to be considered as part of the present patent application. According to these studies, the arch of the orthodontic appliance is modelled as a straight wire, modelled to be able to pass through two non-aligned connections indicated by 41 in FIG. 8 (connections in the present context meaning the usual groove provided in conventional brackets through which the wire of the orthodontic appliance passes).

According to Burnstone's studies, as shown in FIG. 8, the force system generated depends on the system geometry, in particular on the ratio between the angles θₐ and θ_{b}, these angles being those which the connections make to the ideal line joining them. Burnstone has identified six classes defined by six different values of the ratio θ_{b}/θₐ with θₐ>θ_{b} which generate six quantitatively different force systems, these six classes being known as Burnstone classes.

These force systems resolve into vertical forces Fa and Fb, and twisting moments Mₐ and M_{b}.

The six Burnstone classes define six force systems identified by the ratios
F_{b}/Fₐ; M_{b}/Mₐ; Mₐ/Fₐ

The aforesaid articles explain how to obtain a qualitative measurement of the forces and moments generated by the wire of the orthodontic appliance based on the value of the aforesaid angles, the interconnection distance L and the wire characteristics. It should be noted that the value of said angles is given by the tip and torque settings selected for each tooth and by the position selected for said tooth at the malocclusion selection step. According to the invention the calculation unit identifies the Burnstone class to which two consecutive brackets belong taking account of the particular position selected (at the malocclusion selection step) for the teeth of these brackets, the relative tip and torque values and for all three spatial planes.

Advantageously according to the invention to calculate the forces generated by a straight wire of an orthodontic appliance, the calculation unit extracts from its memory the interconnection distances of the brackets for the particular malocclusion being studied, and the Burnstone angles. Knowing the angle to moment ratios for the six classes, a fuzzy logic approximator is applied to calculate the moments on the connections. This calculation uses the tabulated ratios of moments, forces and moments to forces for the six classes defined in the Burnstone article “Force system for an ideal arch”. Having identified the angle ratio, the calculation unit firstly calculates
M_{b}=k₁·θ_{b}/L
then
Mₐ=k₂·M_{b}
and finally
F_{b}=[Mₐ+M_{b}]/L=−Fₐ
where k1 and k2 are the tabulated Burnstone values calculated by approximation by the simulator.

In the first stated Burnstone article [“Systems from an ideal arch” AJO-DO March 1974 (270-288)] the values of k1 and k2 are tabulated for fixed values of the ratio θ_{b}/θₐ which identify the six classes. These values were obtained by an experimental measurement carried out using hardened round steel wire (elastic constant 400000 psi) of dimensions 0.016×0.016 inch.

The programme of the invention calculates the values of k1 and k2 in the following manner:
the tabulated values of k1 are divided by the number
   G=(E·S)/4
   where E is the elastic constant of the material of the wire used in the experimental test (400000 psi) and S is the cross-sectional area of the wire used in the test [π·(0.016/2)²]
the values corresponding to the angle ratio are obtained by non-linear interpolation of the tabulated values (fuzzy logic interpolators)
the value of k1 is multiplied by the number
   G_{f}=(E_{f}·S_{f})/4
   where E_{f} is the elastic constant of the material used for the wire and S_{f} is the cross-section of the wire used.

In the case of non-straight but modelled wires, i.e. activated for example with a V bend or a step (FIGS. 9A,B), the Burnstone studies are not directly applicable and in the literature there are no studies on the force system generated by these forms with non-linear connections.

According to the invention to make the calculation the calculation unit approximates the situation of V or stepped wires to the previously treated situation of straight wires as schematically shown in FIGS. 10A,B. In practice the angles between the connections and the wire branches positioned such as to pass through the centre of the connection and use these angles in a manner totally similar to that previously illustrated in the case of angles formed by straight wire.

Consequently the programme of the invention calculates the force and moment exerted by the wire of the orthodontic appliance on each tooth, again in relation to the angle formed between the groove and the wire passing through the centres of the connection points of two brackets of two adjacent teeth.

According to the invention the calculation unit 2 of the device is arranged to calculate and display for each tooth the movement induced on the teeth by a particular orthodontic appliance and with a particular activation thereof, also taking account of the resistance to movement forces characteristic of the teeth.

For this purpose, when the user has terminated the previously described operations relative to malocclusions, techniques and modelling, the calculation unit carries out the following operations for each tooth:

extracts from the data stored for each tooth the relative centre of resistance and the forces and moments exerted on the tooth by the particular orthodontic appliance and activation selected,

extracts from the stored data, starting from the patient type selected by the user, the characteristic parameters of the resistance to movement related to the biological characteristics of the patient,

compares for each tooth the data relative to the applied force with those relative to the minimum activation threshold; if the applied force is less than the threshold value it feeds an error message to the user and asks for a different activation to be set or a different appliance to be selected,

taking account of the force and moment applied by the selected orthodontic appliance, of the resistance to movement forces characteristic of each tooth and of the selected patient type, it calculates the force and moment effectively acting on each tooth,

it calculates the movement of each tooth at predefined time intervals, for example every seven days,

on the basis of the calculated movement, starting from the selected malocclusion model, or from the last calculated movement for the dental arches, it then proceeds to display the movement induced by the appliance and relative activation selected and/or to report, for each tooth, data identifying the force and moment applied.

The movement of teeth under the action of the external forces is calculated at fixed intervals of one week.

Seeing the minimal extent of movement within this time space, the overall movement is constructed by superposing 6 elementary movements representing the translations and rotations with respect to the 3 axes of the local reference system.

The mathematical model used is of the Mass-Spring-Damper type schematically represented in FIG. 6 for the single dimension case and where the tooth is schematized as an object of rectangular shape identified by the coordinate Xo. In this system the equation of evolution of the position of each tooth is the following:
M·\ddot{x}+β·\dot{c}+k·(x−x₀)=F
where the symbols have the following meanings:

M: mass;

β: friction constant indicated above as damping factor;

k: elastic constant;

F: external force applied by the orthodontic appliance;

Xo: coordinate of the point of force application.

In this manner account is taken of the tooth mass, the friction generated between the tooth and the jaw-bone pair and the tendency of the tooth to return to its original position.

To take account of the fact that the teeth tend to forget their original position after a certain time period, advantageously the point of origin Xo is not fixed but is calculated at each integration step by taking a weighted average of the positions of the last 8 weeks. Advantageously, the elastic constant is not fixed, but varies according to the patient type on which the effect of the orthodontic appliance is to be simulated. This constant is tabulated and stored for three patient types: the brachy patient, the meso patient and the dolicho patient. In the brachy patient for example there is a greater muscular force and hence a greater control over tooth movement. This translates into an increase in resistance and in the value of the constant k.

The numerical calculation is made considering the force F to be constant for the entire week and applying the formula
x[(k+1)·T]=e^{AT}·x(kT)+[e^{AT}−1]·A⁻¹·B·u(kT)
in which:

$$A ≡ \{ \begin{matrix}0 & 1 \\ \frac{- k}{M} & \frac{- β}{M}\end{matrix} \} ; B ≡ \{ \begin{matrix}0 \\ \frac{1}{M}\end{matrix} \}$$

The aforestated formula is repeated six times (the variable x is a “signpost” for the movement and rotation symbols. In other words, given that within the space of one week the movements are small, the total movement can be resolved into three translations along the Cartesian reference axes of the tooth and three rotations about these axes. In particular, the quantities (dx, dy, dz) indicate the elemental movements along the axes and (dax, day, daz) indicate the elemental angles of rotation about the axes.

In this manner, for each individual quantity the indicated formula is applied, where the values of β and k are those relative to that single type of movement.

After calculating the six movements independently, the total movement is obtained by superimposing the individual effects. Having calculated the angles of rotation, this is simulated and displayed about the centre of resistance and not about the geometrical centre of the tooth.

With reference to the screen representation of FIG. 6 relative to simulation, this comprises a dental arch display window equal to the previously described window 11, a virtual pushbutton 51 for loading and displaying the simulation of all steps of the previously selected orthodontic treatment, four virtual pushbuttons 52A-D for quick passage to the previous or next step, two windows 53A-B for graphically displaying the state of advancement in the simulation of the selected treatment step, with reference to the upper arch and lower arch respectively, and two virtual pushbuttons 54A-B to interrupt simulation of the selected treatment step of the lower arch and upper arch respectively. On selecting the activation pushbutton 51 the programme calculates and displays, in accordance with the previously selected settings, a simulation of the effects of the orthodontic appliances of the various treatment steps on the teeth of the virtual arches. If the simulation is too slow and it is desired to pass to the display of the effects of a particular treatment step, for example the last, this can be done by acting on the pushbuttons 52A-C. If during display of the effects of a particular treatment step the user notices an undesired movement of the teeth of the upper and/or lower arch, by acting on the pushbuttons 545A-B the simulation is interrupted and the previous screen relative to modelling is displayed. This screen repeats the parameters relative to the treatment step in which simulation was interrupted. The user is therefore able to check these parameters and modify them.

Finally it should be noted that the aforedescribed embodiment is provided by way of example only, and that numerous variants are possible, all falling within the same inventive concept. For example, a simplified embodiment of the invention could provide only some of the aforedescribed functions. Moreover the data necessary for executing the programme, such as the libraries of malocclusions, techniques, orthodontic appliances and activations, forces resisting tooth movements, and forces exerted by the various appliances, could be stored on conventional storage devices, on which the programme which processes or uses said data is also stored.

1. Device for simulating the effects of a conventional orthodontic appliance on a virtual model of a patient's dental arches, of the type comprising:
a processor presenting a processing unit, interface means comprising at least one display unit;
and at least one memory for storing:
at least one virtual model of the arches of a patient's teeth, and
for at least one conventional orthodontic technique, characteristics identifying at least one orthodontic appliance for implementing said technique, standard parameters of the positioning of said at least one orthodontic appliance on the teeth, and at least one standard activation thereof, a processor programme executable by said processor allowing said virtual model to be accessed and displayed on said display unit,
said programme comprising navigation instruments enabling a user to select said standard orthodontic technique and the relative at least one standard appliance and the at least one standard activation,
said memory comprises at least one parameter describing characteristics of resistance to movement of those teeth subjected to the action of a conventional orthodontic appliance,
said programme associating for said at least one orthodontic technique and for said at least one appliance and activation, for each tooth affected by said appliance, a value relative to the force and/or moment applied by said appliance and activation on each tooth,
said processing unit comprising means for calculating the force and/or moment effectively acting on each of said teeth on the basis of values of force and moment exerted by the orthodontic appliance on the teeth and of the at least one parameter relative to the characteristics of resistance to movement of the teeth subjected to the action of said orthodontic appliance,
said processing unit being arranged to display the movement of the teeth of said virtual model induced by the selected appliance, on the basis of the values of force and moment exerted by the orthodontic appliance on the teeth and of at least one parameter relative to the characteristics of resistance to movement of the teeth subjected to the action of said orthodontic appliance,
said the memory comprising a library of standard orthodontic techniques, and for each technique a library of appliances for implementing said techniques, and a library of activations for said appliances, the programme comprising instruments enabling a user to select from said library of standard orthodontic techniques a technique the effects of which are to be simulated, to select from said library of appliances relative to the selected technique a standard appliance the effect of which is to be simulated, and to select from said library of activations the activation the effect of which is to be simulated.

2. Device as claimed in claim 1, characterised in that the programme calculates for each of the selectable orthodontic techniques and for the relative selectable appliances and activations, for each tooth affected by said appliance, a value relative to the force and/or to the moment applied to each tooth by the appliance and by the relative activation selected.

3. Device as claimed in claim 2, characterised in that the programme comprises instruments enabling the user to choose one of the following activations: no bend, omega loop, droplet loop, vertical loop, L-loop, T-loop, looped vertical loop, double looped vertical loop, stepped bends, V bends.

4. Device as claimed in claim 1, characterised in that the processor programme comprises instruments enabling a user to display in correspondence with each tooth of the virtual model at least one value representative of the force and/or moment applied to the relative tooth for the technique, appliance and activation to be simulated.

5. Device as claimed in claim 1, characterised in that the memory comprises data indicative of a plurality of different patient types and, for each of said types, at least one characteristic parameter able to describe the characteristics of resistance to movement of the teeth subjected to the action of an orthodontic appliance, said programme comprising instruments enabling the user to select one of said patient types.

6. Device as claimed in claim 1, characterised in that the at least one parameter describing the movement resistance characteristics is chosen from the following parameters: a parameter indicative of the return force acting on each tooth in opposition to that exerted by the orthodontic appliance, a parameter indicative of the friction force acting on each tooth in opposition to that exerted by the orthodontic appliance, a parameter indicative of the minimum movement activation threshold of each tooth, a parameter indicative of the interdental elastic bond, a parameter indicative of the jaw muscular force, a parameter indicative of the mass of each tooth.

7. Device as claimed in claim 1, characterised in that the memory comprises for each tooth the positions of the relative centres of resistance.

8. Device as claimed in claim 1, characterised in that the processing unit comprises means for calculating the force and moment generated by the orthodontic appliance and by the relative activation on each tooth, independently of the action of the forces of resistance of the teeth to the action of said orthodontic appliance.

9. Device as claimed in claim 8, characterised in that, for calculating the force and moments generated by the orthodontic appliance on each tooth independently of the characteristic forces of resistance to the movement of each tooth, the calculation means use the measurement of the interconnection distances of the brackets of the orthodontic appliance, of the Burnstone angles, and the angle to moment ratios for the six Burnstone classes.

10. Device as claimed in claim 9, characterised in that for calculating the force and moments generated by the orthodontic appliance on each tooth, for each pair of adjacent teeth on which brackets are mounted, the calculation means use the measurement of the interconnection distance and the angles formed between the bracket grooves and the wire passing through the centre of the bracket connection points.

11. Device as claimed in claim 1, characterised in that the processor programme comprises a step of calculating the force effectively applied by the orthodontic appliance on each tooth, this step comprising the following operations:
extracting from the stored data for each tooth the relative centre of rotation and forces and moments exerted on the tooth by the particular technique, orthodontic appliance and activation selected,
extracting from the stored data, starting from the patient type selected by the user, the characteristic parameters of the resistance to movement related to the biological characteristics of the patient,
comparing for each tooth the data relative to the applied force with those relative to the minimum activation threshold; if the applied force is less than the threshold value it feeds an error message to the user,
taking account of the force and moment applied by the selected orthodontic appliance, of the resistance to movement forces characteristic of each tooth and of the selected patient type, calculating the force and moment effectively acting on each tooth,
calculating the movement of each tooth within predefined time intervals,
on the basis of the calculated movement, starting from the selected malocclusion model, or from the last calculated movement of the teeth of the dental arches, displaying the movement induced by the appliance and relative activation selected and/or reporting, for each tooth, data identifying the force and moment applied.

12. Device as claimed in claim 1, characterised in that the programme for calculating the force effectively applied to the orthodontic appliance on each tooth uses for the forces acting overall on each tooth a model of mass-spring-damper type.

13. Method for simulating the effects of a conventional orthodontic appliance on a virtual model of the dental arches of a patient, of the type comprising:
a step of memorizing
at least one virtual model of the arches of a patient's teeth, and
for at least one conventional orthodontic technique, characteristics identifying at least one orthodontic appliance for implementing said technique, standard parameters of the positioning of said at least one orthodontic appliance on the teeth, and at least one standard activation thereof,
a step of selecting said virtual model and of displaying the selected model, a step of selecting said standard orthodontic technique of the relative at least one standard appliance and of the at least one standard activation thereof,
a step of memorizing at least one parameter describing characteristics of resistance to movement of those teeth subjected to the action of a conventional orthodontic appliance.
a step which for said at least one orthodontic technique and for said at least one appliance and activation, associates with each tooth a value relative to the force and/or moment applied by said appliance and activation on each tooth,
a step of calculating the force and/or moment effectively acting on each of the teeth on the basis of the values of force and moment exerted by the orthodontic appliance on the teeth and of the at least one parameter relative to the characteristics of resistance to movement of the teeth subjected to the action of said orthodontic appliance,
a step of processing a display of the movement of the teeth of said virtual model induced by the selected appliance, processed on the basis of the values of force and moment exerted by the orthodontic appliance on the teeth and of the at least one parameter relative to the characteristics of resistance to movement of the teeth subjected to the action of said orthodontic appliance,
a step of memorizing a library of standard orthodontic techniques, and for each technique a library of appliances able to implement said techniques, and a library of activations for said appliances, and a step of selecting from said library of standard orthodontic techniques a technique the effects of which are to be simulated, selecting from said library of appliances relative to the selected technique a standard appliance the effect of which is to be simulated, and selecting from said library of activations the activation the effect of which is to be simulated,
a step of displaying in correspondence with each tooth of the virtual model at least one value representative of the force and/or moment applied to the relative tooth for the technique, appliance and activation to be simulated.

14. Method as claimed in claim 13, characterised by comprising a step of memorizing data indicative of a plurality of different patient types and, for each of said types, at least one characteristic parameter able to describe the characteristics of resistance to movement of the teeth subjected to the action of an orthodontic appliance, said programme comprising instruments enabling the user to select one of said patient types.

15. Method as claimed in claim 14, characterised in that the at least one parameter describing the characteristics of resistance to movement is chosen from the following parameters: a parameter indicative of the return force acting on the tooth opposing that exerted by the orthodontic appliance, a parameter indicative of the friction force acting on the tooth opposing that exerted by the orthodontic appliance, a parameter relative to the minimum movement activation threshold of each tooth, a parameter indicative of the interdental elastic bond, a parameter indicative of the jaw muscular force, a parameter indicative of the mass of each tooth.

16. Method as claimed in claim 13, characterised by memorizing for each tooth the positions of the relative centres of resistance.

17. Method as claimed in claim 13, characterised by calculating the force and moment generated by the orthodontic appliance and by the relative activation on each tooth, independently of the action of the forces of resistance of the teeth to the action of said orthodontic appliance and by using, for calculating the force and moments generated by the orthodontic appliance on each tooth independently of the characteristic forces of resistance to the movement of each tooth, the measurement of the interconnection distances of the brackets of the orthodontic appliance, of the Burnstone angles, and of the angle to moment ratios for the six Burnstone classes.

18. Method as claimed in claim 13, characterised by using, for calculating the force and moments generated by the orthodontic appliance on each tooth, for each pair of adjacent teeth on which brackets are mounted, the measurement of the interconnection distance and the angles formed between the bracket grooves (41) and the wire passing through the centre of the bracket connection points.

19. Method as claimed in claim 13, characterised by calculating the force effectively applied by the orthodontic appliance on each tooth, this step comprising the following operations:
extracting from the stored data for each tooth the relative centre of rotation and forces and moments exerted on the tooth by the particular technique, orthodontic appliance and activation selected,
extracting from the stored data, starting from the patient type selected by the user, the characteristic parameters of the resistance to movement related to the biological characteristics of the patient,
comparing for each tooth the data relative to the applied force with those relative to the minimum activation threshold; if the applied force is less than the threshold value it feeds an error message to the user,
taking account of the force and moment applied by the selected orthodontic appliance, of the resistance to movement forces characteristic of each tooth and of the selected patient type, calculating the force and moment effectively acting on each tooth,
calculating the movement of each tooth within predefined time intervals,
on the basis of the calculated movement, starting from the selected malocclusion model, or from the last calculated movement of the teeth of the dental arches, displaying the movement induced by the appliance and relative activation selected and/or reporting, for each tooth, data identifying the force and moment applied.

20. Method as claimed in claim 13, characterised by using, in calculating the force effectively applied to the orthodontic appliance on each tooth, a model of mass-spring-damper type for the forces acting overall on each tooth.
